(19) United States
(12) Patent Application Publication
(10) Pub. No.: US 2026/0101187 A1
(43) Pub. Date: Apr. 9, 2026

(54) PROTECTING USER PRIVACY WHILE BOOTSTRAPPING AN APPLICATION FUNCTION (AF) KEY FROM PRIMARY AUTHENTICATION

(71) Applicant: InterDigital Patent Holdings, Inc., Wilmington, DE (US)

(72) Inventors: Zhibi Wang, Woodridge, IL (US); Samir Ferdi, Kirkland (CA); Alec Brusilovsky, Downingtown, PA (US)

(73) Assignee: InterDigital Patent Holdings, Inc., Wilmington, DE (US)

(21) Appl. No.: 18/905,889

(22) Filed: Oct. 3, 2024

(51) Int. Cl. H04W 12/069; H04W 12/0433

(52) U.S. Cl. CPC H04W 12/069; H04W 12/0433

(57) ABSTRACT

Methods and apparatus for protecting user privacy while bootstrapping an application function (AF) key from primary authentication are provided herein. In an example, a WTRU derives a K_{AKMA} key for authentication and key management for applications (AKMA). Also, the WTRU derives a K_{AF} key for an AF and a K_{AF} key identity (ID) identifying the K_{AF} key. Further, the K_{AF} key and a K_{AF} key ID are derived based on a freshness parameter, the K_{AKMA} key, an AF ID identifying the AF, and a WTRU ID identifying the WTRU. The WTRU then transmits, to a network node, the freshness parameter, the AF ID and the WTRU ID. Also, the WTRU transmits to the AF, the KAF key ID. Moreover, the WTRU performs mutual authentication with the AF using the KAF key. In an example, the WTRU may also receive a key establishment confirmation, from the AF, for the K_{AF} key.

### BACKGROUND

In Fifth Generation (5G) wireless communication, a primary authentication of the handset, or wireless transmit/receive unit (WTRU), is performed before the WTRU is authorized to access network services. In the primary authentication, the shared secret between universal subscriber identity module (USIM) of the WTRU and the same stored by the unified data management (UDM)/unified data repository (UDR) of the operator network is used. After successful primary authentication, the WTRU is admitted to network and the connection is secured using the derived session keys.

### SUMMARY

Methods and apparatus for protecting user privacy while bootstrapping an application function (AF) key from primary authentication are provided herein. In an example, a WTRU derives a K_{AKMA} key for authentication and key management for applications (AKMA). Also, the WTRU derives a K_{AF} key for an AF and a K_{AF} key identity (ID) identifying the K_{AF} key. Further, the K_{AF} key and a K_{AF} key ID are derived based on a freshness parameter, the K_{AKMA} key, an AF ID identifying the AF, and a WTRU ID identifying the WTRU. The WTRU then transmits, to a network node, the freshness parameter, the AF ID and the WTRU ID. Also, the WTRU transmits to the AF, the K_{AF} key ID. Moreover, the WTRU performs mutual authentication with the AF using the K_{AF} key.

In an example, the WTRU may also receive a key establishment confirmation, from the AF, for the K_{AF} key. Additionally or alternatively, the WTRU transmits a first secure message, to the AF, using one or more first session keys derived from the K_{AF} key. Additionally or alternatively, the WTRU receives a second secure message, from the AF, using one or more session keys derived from the K_{AF} key.

Additionally or alternatively, the WTRU transmits the K_{AF} key ID to the network node. Additionally or alternatively, the network node is an AKMA anchor function (AAnF).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a hierarchy diagram illustrating an example of an authentication and key management for applications (AKMA) key hierarchy;

FIG. 3 is a signaling diagram illustrating an example of an AKMA key registration with an AKMA anchor function (AAnF);

FIG. 4 is a signaling diagram illustrating an example of an application function (AF) key K_{AF} derivation from an AKMA anchor key (K_{AKMA});

FIG. 5 is a signaling diagram illustrating an example of privacy protected AF Key bootstrapping;

FIG. 6 is a signaling diagram illustrating an example of a concealment of a parameter between a WTRU and an AAnF; and

FIG. 7 is a flowchart diagram illustrating an example of privacy protected AF Key bootstrapping.

### DETAILED DESCRIPTION

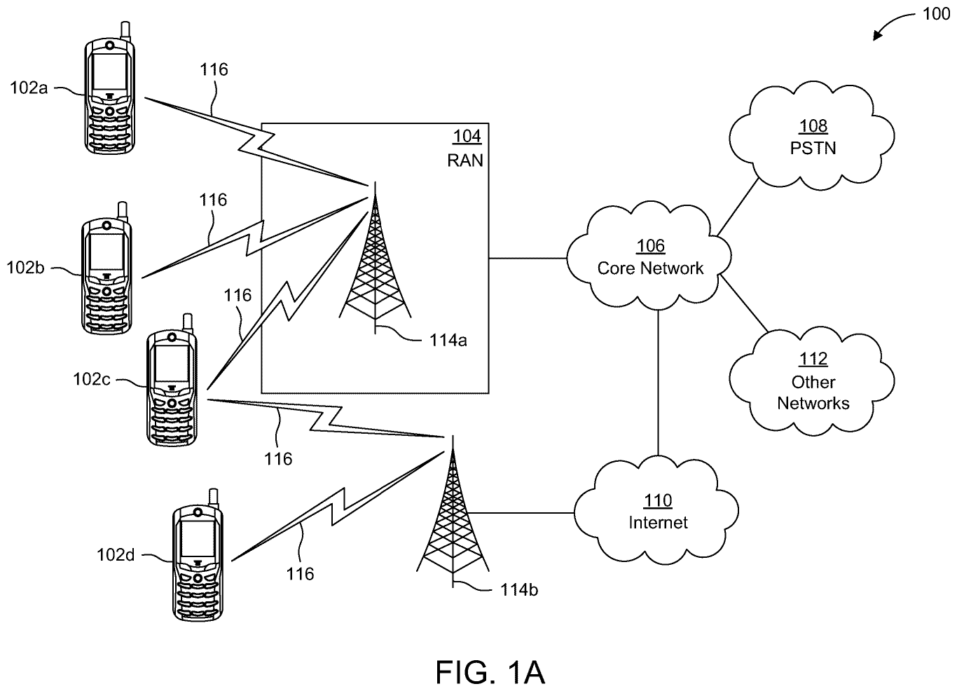

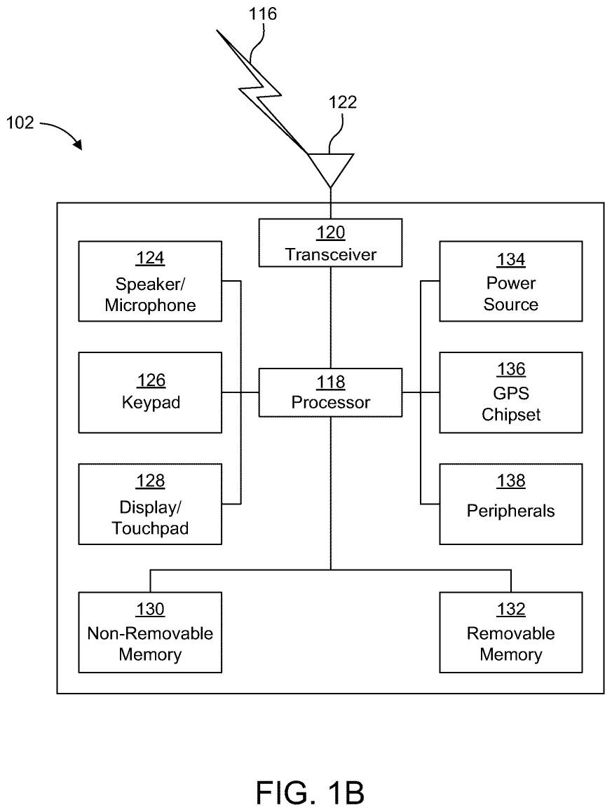

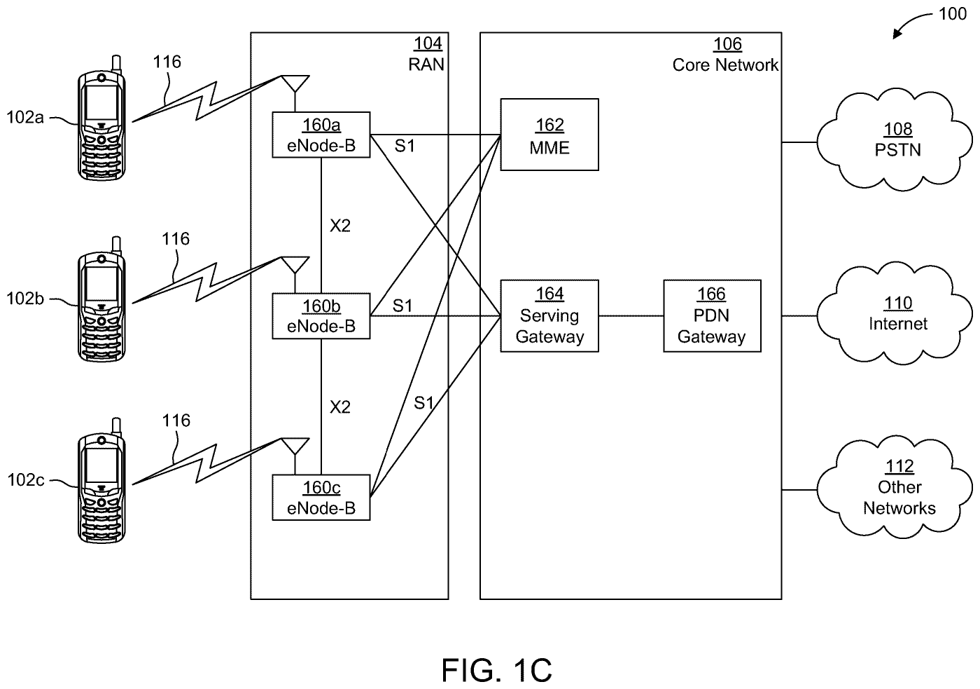

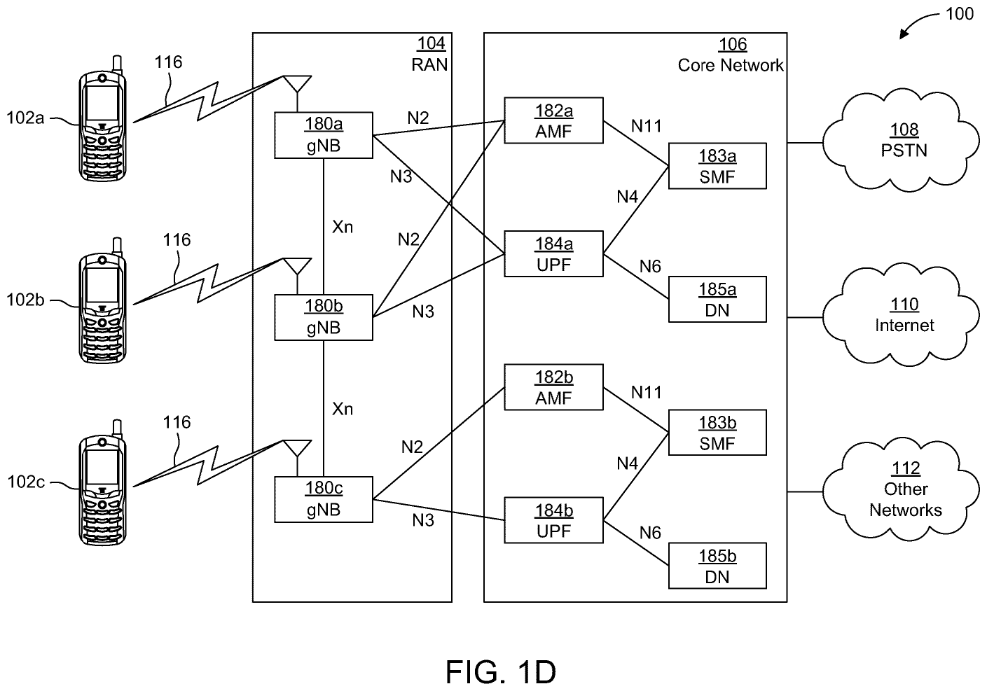

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

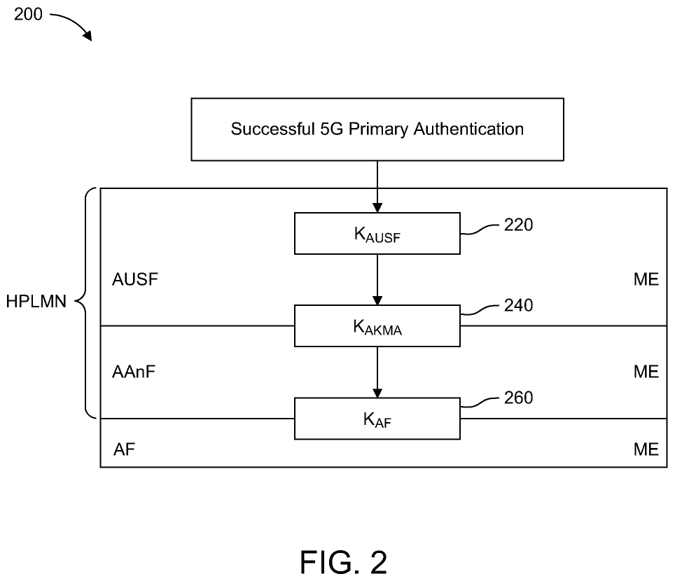

FIG. 2 is a hierarchy diagram illustrating an example of an authentication and key management for applications (AKMA) key hierarchy. As shown in hierarchy diagram 200, an Authentication Server Function (AUSF) is used. The AUSF was introduced in 5G systems to manage the WTRU authentication using the subscription concealed identifier SUCI or the subscription permanent identifier (SUPI), and to manage the root session key K_{AUSF} 220 and the WTRU and network derived further keys from the K_{AUSF} 220. Further, a K_{AKMA} 240 is generated that is used to bootstrap the security credential between the WTRU and application function (AF) K_{AF} 260.

The AKMA key K_{AKMA} 240 is derived from the K_{AUSF} 220. A K_{AKMA} Key ID, i.e., A-KID, is also derived when the WTRU derives the key, the network derives the key, or both derive the key. A-KID is in network access identifier (NAI) format, e.g., username@realm. The username part shall include the Routing Identifier and the AKMA Temporary UE Identifier (A-TID), and the realm part shall include Home Network Identifier.

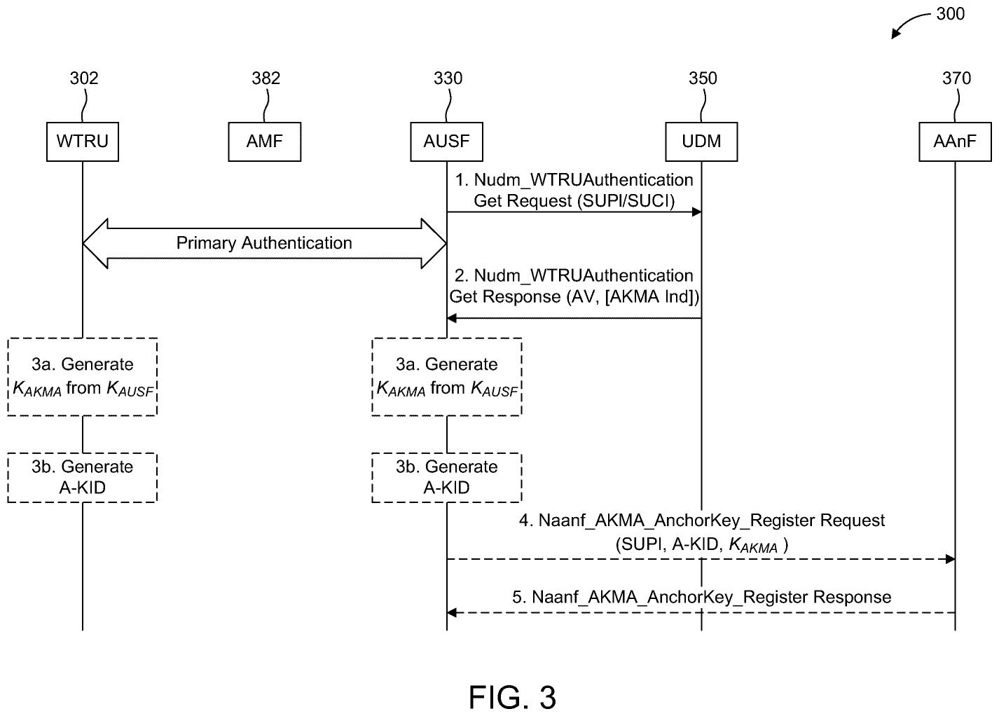

FIG. 3 is a signaling diagram illustrating an example of an AKMA key registration with an AKMA anchor function (AAnF). Signaling diagram 300 shows that after the primary authentication of a WTRU 302, the AKMA key K_{AKMA} is derived from the key K_{AUSF}. Correspondingly, a AKMA Key ID A-KID is also generated at the WTRU 302 and an AUSF 330. The A-KID is also used as an identifier for the AKMA key. In an example, the A-KID may be used temporarily. After that, the AUSF 330 registers the K_{AKMA} along with the A-KID and WTRU identity SUPI to the NF AAnF 370 using one or more of the following steps. In an example, WTRU 302 may be the same as or similar to WTRU 102.

At step 1, during the primary authentication procedure, the AUSF 330 interacts with the UDM 350 in order to fetch authentication information such as subscription credentials (e.g. AKA Authentication vectors) and the authentication method using the Nudm_UEAuthentication_Get Request service operation. In an example, an AMF 382 may assist as an intermediary between the WTRU 302 and the AUSF 330 during the primary authentication procedure.

At step 2, in the response, the UDM 350 may also indicate to the AUSF 330 whether AKMA Anchor keys need to be generated for the WTRU 302.

At step 3, if the AUSF 330 receives the AKMA indication from the UDM 350, the AUSF 330 shall store the K_{AUSF} and generate the AKMA Anchor Key (K_{AKMA}) and the A-KID from K_{AUSF.} The WTRU 302 shall generate the AKMA Anchor Key (K_{AKMA}) and the A-KID from the K_{AUSF} before initiating communication with an AKMA Application Function (not shown).

At step 4, after AKMA key material is generated, the AUSF 330 shall send the generated A-KID, and K_{AKMA} to the AAnF 370 together with the SUPI of the WTRU 302 using the Naanf_AKMA_KeyRegistration Request service.

At step 5, the AAnF 370 sends the response to the AUSF 330 using the Naanf_AKMA_AnchorKey_Register Response service operation.

Before communication between the WTRU and the AKMA AF can start, the WTRU and the AF need to bootstrap the application layer key from the K_{AKMA}.

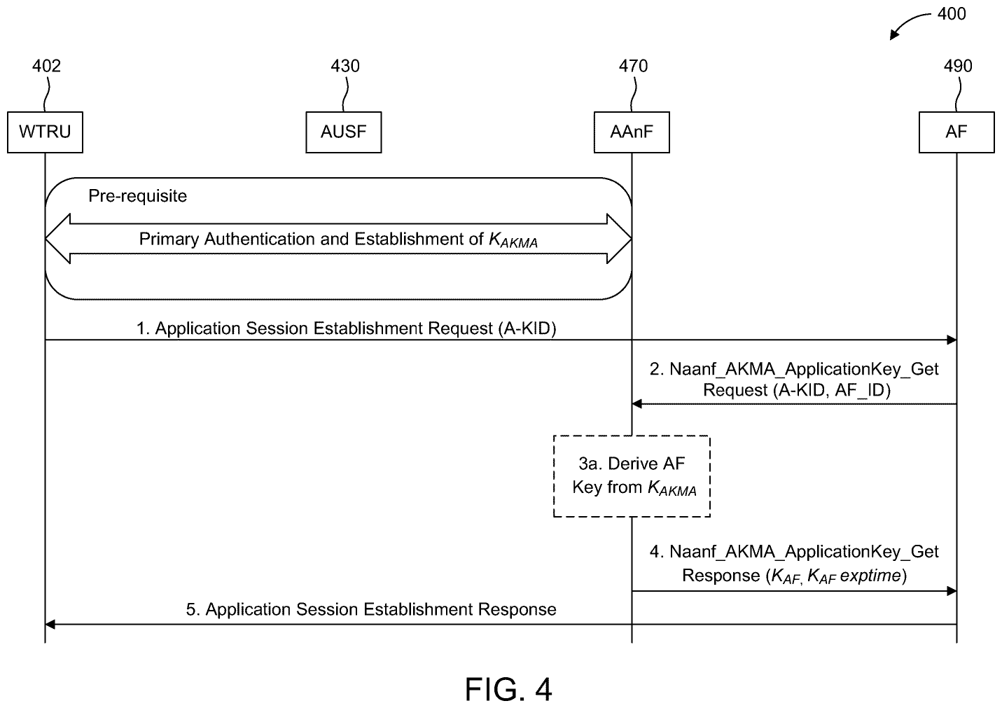

FIG. 4 is a signaling diagram illustrating an example of an AF key K_{AF} derivation from a K_{AKMA}. A prerequisite to the K_{AF} key derivation is the primary authentication and establishment of a K_{AKMA} among a WTRU 402, an AUSF 430 and an AAnF 470. In examples shown in FIG. 4, the AAnF 470 may operate similar to the AAnF 370 shown in FIG. 3. In an example, WTRU 402 may be the same as or similar to WTRU 102.

Further, examples as shown in signaling diagram 400 include the use of an AF 490 which may be a trusted AF or an untrusted AF. In an example in FIG. 4, a trusted AF 490 within the trusted public land mobile network (PLMN) core interacts with the AAnF 470, and a key K_{AF} is generated to secure the communication between the WTRU 402 and the trusted AF 490. In another example in FIG. 4, an untrusted AF 490 outside the PLMN core interacts with the AAnF 470 via a network exposure function (NEF), which is not shown. Further, a key K_{AF} is generated like the procedure in FIG. 4 with the NEF between the AAnF 470 and the AF 490.

When the WTRU 402 initiates communication with the AAnF (or AKMA AF) 430, it shall include the derived A-KID in the Application Session Establishment Request message, as shown in step 1 in FIG. 4. WTRU 402 may derive K_{AF} before sending the message or afterwards.

If the AF 490 does not have an active context associated with the A-KID, then the AF 490 sends a Naanf_AKMA_ApplicationKey_Get request to the AAnF 470 with the A-KID to request the K_{AF} for the WTRU 402, as shown in step 2 in FIG. 4. The AF 490 also includes its identity (AF ID) in the request. The AAnF 470 shall check whether the AAnF 470 can provide the service to the AF 490 based on the configured local policy or based on the authorization information or policy provided by the network repository function (NRF) using the AF ID. If the AAnF 470 can provide the service, the procedure continues. Otherwise, the AAnF 470 shall reject the procedure.

The AAnF 470 derives, as shown in step 3a in FIG. 4, the AKMA Application Key (K_{AF}) from K_{AKMA} if it does not already have K_{AF}.

The AAnF 470 sends a Naanf_AKMA_ApplicationKey_Get response to the AF 490 with the K_{AF} and the K_{AF} expiration time, as shown in step 4 in FIG. 4.

The AF 470 sends an Application Session Establishment Response message to the WTRU 402, as shown in step 5 in FIG. 4. If the information in step 4 indicates failure of AKMA key request, the AF 490 shall reject the Application Session Establishment by including a failure cause in the response message.

In current 5G systems, a function entity called an Authentication Proxy (AP) was added with multiple Application Servers (ASs) attached to it to enable AKMA based security with ASs that may not support AKMA procedures. The AP is a proxy which takes the role of an AF and delegates a group of ASs. The AP resides between the WTRU and the AS. The AP helps the ASs behind the AP to execute AKMA procedures to save the consumption of signaling resources and AAnF computing resources. It may also relieve the AS of security tasks.

3GPP specified new protocols for authentication and key management services in 5G. AKMA is the mechanism that bootstraps the keys after primary authentication, in order to establish secure communication between a WTRU and one or more AFs. To ensure communication security between the WTRU and AF, AKMA must meet strong security properties. However, potential privacy attacks may be constructed against AKMA procedures.

Some research has identified privacy issues in 5G AKMA service, and these privacy issues are specified in natural language as follows. One issue is that the AFs should not know a user's identity at the home network. Another issue is that one AF cannot link one of its users with a user of another AF, even when those two AFs collude. A further issue is that the home network should not know the name of the AFs that a WTRU connects to.

In addition, exposing an A-KID can cause linkability issues. Unless the primary authentication is repeated, the A-KID value remains the same and continues to be used by the same user. Tracking the A-KID makes it easy to link the same user using many other applications.

In linkage of the A-KID, the same A-KID is linked to a K_{AKMA}, and therefore to the same SUPI, or the same user. Since the protocol uses the same A-KID across all AFs by the same user, the A-KID can be used to track the user or learn privacy information, such as by tracking all the AFs that one user may associated with.

A potential solution that could use existing AKMA and relies on transport layer security (TLS) deployments with an encrypted client hello (ECH) extension can be one option to address the issue. But the limitation of such a solution is that it would mandate the deployment of TLS with support for that the ECH extension on both client and server sides. Furthermore, this mechanism is not specified for AKMA procedures (which may use the Ua* interface), it would make it hard to implement and ensure interoperability among many stakeholders (e.g., WTRU vendors, AF providers).

The solutions in this disclosure addresses the following issues. Specifically, the solutions address how to protect the privacy of WTRU in bootstrapping the application function key. Further, the solutions address how to protect the communication of the Key ID between the WTRU and AF, and prevent the linkability when the same A-KID is used between the WTRU and different AFs. More specifically, the solutions address how to ensure privacy of an AKMA key identifier exchanged between the WTRU and AF.

AKMA is the mechanism that bootstraps the keys after primary authentication to establish secure communication between WTRU and AFs. The same AKMA key ID A-KID is used in the request from the WTRU to all AFs when the same AKMA key is used during the key bootstrapping procedure according to the current specification. The proposed mechanisms provided in embodiments and examples herein mitigate privacy attacks (e.g., trackability, linkability) due to A-KID exposure by using a key identifier privacy preserving protocol between the WTRU, network and AF.

Embodiments and examples provided herein include the following solutions. For WTRU triggered Key requests, the WTRU generates a fresh parameter and derives K_{AF} and a key ID of K_{AF} using the freshness parameter, AF ID, UE ID (or WTRU ID), and the like. The K_{AF} key ID is AF-specific and will be used to establish the security protection of communications with the AF. To protect user privacy, the globally unique K_{AKMA} Key ID A-KID is not used between the WTRU and the AF. Instead, the derived K_{AF} Key ID is used. In embodiments and examples provided herein, the freshness parameter is directly sent to the core network from the WTRU along with the AF ID, and UE ID (or WTRU ID) in the key generation request via a NAS message without being sent to the AF. Additionally or alternatively, the K_{AF} Key ID is also sent to the core network from the WTRU.

Additionally or alternatively in embodiments and examples provided herein, the freshness parameter can be included in the application session establishment request by WTRU to the AF along with K_{AF} Key ID, AF ID, and WTRU ID. The K_{AF} Key ID and the AF ID may be integrity-protected between the WTRU and the core network. When the WTRU receives key confirmation from the AF, the WTRU and the AF perform mutual authentication. Further, one or more session keys derived from the K_{AF} may then be used between the WTRU and the AF. The WTRU may authenticate the AF using the AF public key infrastructure. Additionally or alternatively, the A-KID, WTRU ID or any other parameters sent by the WTRU to the AF may be concealed by the WTRU and de-concealed by the core network using an encryption key that is derived using a mobile network operator (MNO) public key.

Embodiments and examples provided herein include key bootstrapping using a privacy preserving AKMA application key ID. In an example for a WTRU triggered Key request, the WTRU generates a freshness parameter and derives K_{AF} and a key ID of K_{AF} using the freshness parameter, AF ID, UE ID (or WTRU ID), and the like. as inputs to the key derivation functions. The K_{AF} key ID is AF specific that will be used to establish the security protection of communications with the AF. To protect the user privacy, the globally unique K_{AKMA} Key ID A-KID is not used between the WTRU and the AF. Instead, the derived K_{AF} Key ID is used.

Additionally or alternatively, in an example, the freshness parameter is directly sent to the core network from the WTRU along with the AF ID, UE ID (or WTRU ID), and the like, in the key generation request via a NAS message without being sent to the AF. The AMF can forward the request to the AAnF based on the WTRU's Routing Indicator (e.g., as part of K_{AF} Key ID). Additionally or alternatively, the K_{AF} Key ID is also sent to the core network from the WTRU.

Additionally or alternatively, in another example, the freshness parameter can be included in the application session establishment request by WTRU to the AF along with K_{AF} Key ID, AF ID, and UE ID (or WTRU ID). The K_{AF} Key ID and the AF ID are integrity protected by the WTRU. For example, the WTRU can generate a one-time integrity key (with K_{AKMA}, a nonce such as a counter, etc., as the inputs to a key derivation function) to integrity protect the parameters.

When the WTRU receives key confirmation from the AF, the WTRU and the AF perform mutual authentication. Further, one or more session keys derived from the K_{AF} may then be used between the WTRU and the AF. The WTRU may authenticate the AF using the K_{AF}.

In an example, a WTRU may request AF key derivation. The AAnF receives the key generation request that contains the freshness parameter directly from the WTRU (e.g., via the AMF) along with the A-KID, AF ID, and WTRU ID in the key generation request via a NAS message. Additionally or alternatively, the K_{AF} Key ID is also sent to the AAnF from the WTRU.

Further, the AAnF derives the AF key K_{AF} and the K_{AF} Key ID in the same way as the WTRU (e.g., using the same key derivation function (KDF) and input parameters) and stores it to be requested from the AF.

When the AAnF receives the K_{AF} Key request from the AF, which contains parameters such as K_{AF} Key ID, AF ID, WTRU ID, freshness parameter, and the like, that are integrity protected by the WTRU using a one-time integrity key, the core network authenticates and authorizes the AF. The AAnF then derives the same one-time integrity key as the WTRU, and validates the integrity of the parameters such as AF ID. Further, the AAnF compares the integrity validated AF ID with the AF ID sent by the AF to validate the AF ID. If the validation is successful, the core network retrieves the K_{AF} using received K_{AF} ID, and sends the K_{AF} Key, and the K_{AF} expiring time back to the AF.

In another example, the AF may request AF key derivation. The AAnF receives the key request from the AF that contains a freshness parameter along with K_{AF} Key ID, AF ID, and WTRU ID. The K_{AF} Key ID, and the AF ID are integrity protected (e.g., integrity protected by WTRU using the one-time integrity key derived, as in the example above regarding the WTRU requesting the AF key derivation.

The AAnF authenticates and authorizes the AF, and derives the same one-time integrity key the same way as WTRU. Further, the AAnF then integrity validates the freshness parameter, AF ID, and WTRU ID. If the integrity validated AF ID is the same as the AF ID of the AF that sends the request, the AAnF derives the K_{AF} key and Key ID in the same way as the WTRU (e.g., the same KDF and input parameters). Then the AAnF compares the derived Key ID and the received Key ID. If the Key ID matches, the AAnF in the 3GPP core network responds to the key request from the AF with the K_{AF} Key, K_{AF} ID, and the K_{AF} expiring time.

Embodiments and examples provided herein include key bootstrapping using a concealed WTRU or AKMA Key Identifier. In an example, the WTRU conceals the A-TID part of the A-KID and any other parameters between the WTRU and the AAnF using operator's public key, before WTRU sends the Application Session Establishment request to the AF.

Additionally or alternatively, when the Application Key Request is received from the AF, the AAnF sends a request to the unified data management (UDM)/subscriber identity de-concealing function (SIDF) to un-conceal the A-KID. After the AAnF receives the un-concealed A-KID, the AAnF proceeds to derive the K_{AF} and sends back the K_{AF} to the AF along with the K_{AF} expiring time.

Embodiments and examples are provided herein with specific solutions to the problems described above. For WTRU-triggered Key requests, the WTRU generates a fresh parameter and derives K_{AF} and the key ID of K_{AF} using the freshness parameter, AF ID, WTRU ID, and the like. The K_{AF} key ID is AF-specific and will be used to negotiate the security protection with the AF. To protect user privacy, the global unique K_{AKMA} Key ID A-KID is not used between the WTRU and the AF. Instead, the derived K_{AF} Key ID is used. In addition, the communication to send the key request between the WTRU and the AF is protected, such as by the hypertext transfer protocol secure (HTTPS) or TLS protocols. The AF then securely communicates with AAnF in the 3GPP core network to retrieve the AF key using the K_{AF} Key ID.

In an example, the freshness parameter is directly sent to the core network from the WTRU along with the AF ID, WTRU ID, and the like, in the key generation request via a NAS message without being sent to the AF. Additionally or alternatively, the K_{AF} Key ID is also sent to the core network from the WTRU. When the core network receives the request, the core network derives the same key as in the WTRU and stores the key to be requested from the AF. The WTRU generates a one-time integrity key with the K_{AKMA}, a nonce such as a counter, and the like, as the inputs to a key derivation function to integrity protect the parameters such as the AF ID. Further, the WTRU then starts the session establishment request with the AF. In this case, when the AF receives the K_{AF} Key ID from the WTRU, the AF requests the K_{AF} from the core network with the integrity protected parameters such as K_{AF} Key ID and AF ID received from WTRU in the request to the AAnF in the 3GPP core network.

When the 3GPP core network receives the K_{AF} Key ID in the key request from the AF, the core network authenticates and authorizes the AF. The 3GPP core network then routes the key request to the AAnF that is associated with the WTRU, for example, via the routing information as part of the K_{AF} Key ID. The AAnF generates a one-time integrity key in the same way as the WTRU (with K_{AKMA}, a nonce such as a counter, etc., as the inputs to a key derivation function) to integrity protect the parameters. The AAnF then validates the integrity of the parameters such as K_{AF} Key ID and AF ID from the WTRU, and compares integrity validated AF ID with the AF ID sent by the AF to validate the two AF ID matches. If the integrity validation is successful, the core network derives the K_{AF} using received freshness parameter, AF ID, WTRU ID, and the like, and sends the K_{AF} Key, K_{AF} ID, and the K_{AF} expiring time back to AF.

In the same request message to request the K_{AF}, or after receiving the K_{AF} from the AAnF in the 3GPP core network, the AF subscribes the K_{AF} Key updates notification with the subscription message that can be combined with the K_{AF} key request message. The subscription enables the AF to receive the notification of K_{AF} Key update as the results of key updates from the AAnF in the 3GPP core network, whenever the WTRU performs reauthentication, the K_{AF} expires, the user service changes, the subscription changes, key invocation is performed, and the like. Further, the AAnF in the 3GPP core network updates the K_{AF} Key and notifies the AF of the new key K_{AF}.

Additionally or alternatively in another example, the WTRU generates a freshness parameter and one-time integrity key with K_{AKMA}, a nonce such as a counter, and the like, as the inputs to a key derivation function. The WTRU sends the application session establishment request to the AF along with the freshness parameter, K_{AF} Key ID, AF ID, and WTRU ID that are integrity protected using the integrity key just generated.

After receiving the request, the AF forwards the freshness parameter to the AAnF in the 3GPP core network in the key request/subscription message, along with K_{AF} Key ID, AF ID, and the AF ID integrity protected by the WTRU. The routing to the AAnF associated with the WTRU by the 3GPP core network is based on the routing information as part of the K_{AF} Key ID.

After the AAnF in the 3GPP core network authenticates and authorizes the AF, the AAnF generates the one-time integrity key in the same way as the WTRU (with K_{AKMA}, the nonce such as a counter, and the like as the inputs to a key derivation function). The AAnF then validates the integrity of the parameters. If the integrity protected AF ID is the same as the AF ID that sends the request, the AAnF in the 3GPP core network derives the K_{AF} key and Key ID. Then the AAnF in the 3GPP core network compares the derived Key ID and the received Key ID. If the Key ID matches, the AAnF in the 3GPP core network responds the key request to the AF with the K_{AF} Key, K_{AF} ID, and the K_{AF} expiring time.

The AF and the WTRU performs mutual authentication using the K_{AF}. If the K_{AF} Key is refreshed as the results such as a new primary authentication, between WTRU and the core network, the AF will be notified, and the AF receives the new K_{AF} Key, and WTRU and AF can continue to protect the existing session using the new K_{AF} Key.

Examples provided herein include consideration of the AF acting as an Authentication Proxy (AP) for multiple Application Servers. Between the WTRU and the Authentication Proxy (AP) is the Ua* interface that may be hypertext transfer protocol (HTTP) based. The Authentication Proxy (AP) is a reverse proxy to handle the communication between the WTRU and the AS. The Authentication Proxy (AP) takes the role of an AF. The AKMA Application Key (i.e. K_{AF}) is utilized between the WTRU and the Authentication Proxy (AP), that is derived based on the fully qualified domain name (FQDN) of the AP. Since the Authentication Proxy (AP) may act as a reverse proxy that hides IP/domain name system (DNS) information about the AS(s) it proxies, the solution described herein provides means to mitigate tracking of user based on key id across multiple Application Servers.

That is to say, since the K_{AF} is used between the WTRU and the Authentication Proxy (AP) based on a solution herein, the K_{AF} Key ID is only valid for this Authentication Proxy (AP). Therefore, any trackability or linkability issue should be mitigated using the mechanisms described herein when the AKMA based security is established between the WTRU and an Authentication Proxy (AP).

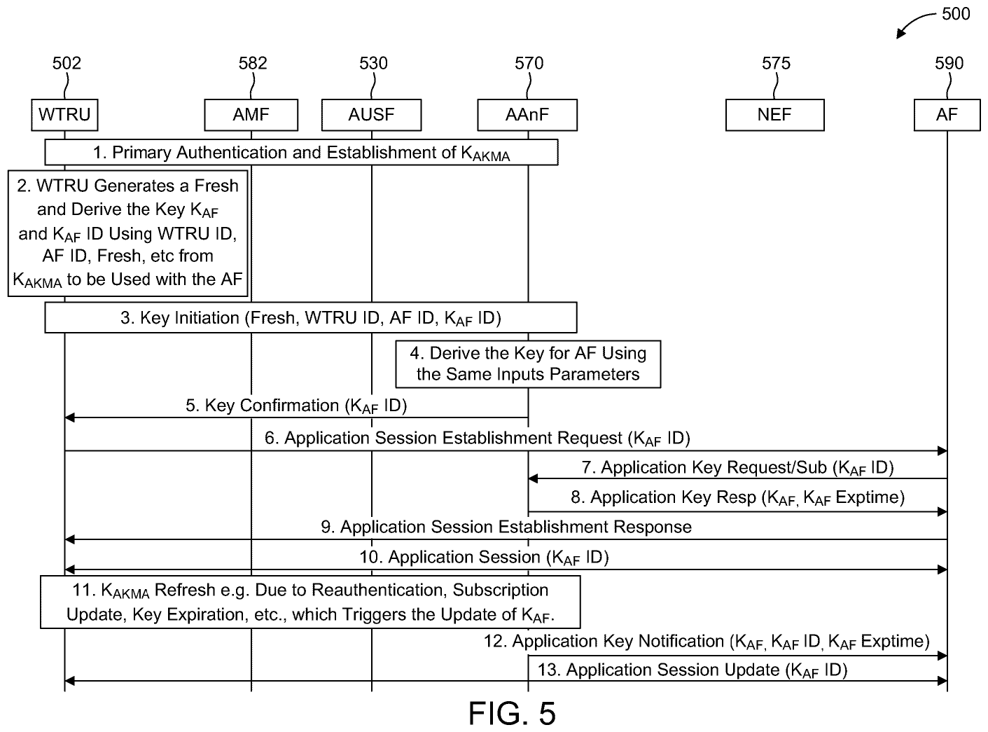

FIG. 5 is a signaling diagram illustrating an example of privacy protected AF Key bootstrapping. As shown in an example in signaling diagram 500, in step 1, after primary authentication, WTRU 502 and the 3GPP core network derive a K_{AKMA} that will be used to further bootstrap the AF key later. In this way, K_{AKMA} key establishment may be performed. In an example, WTRU 502 may be the same as or similar to WTRU 102. Further, the core network may include one or more of AMF 582, AUSF 530 and AAnF 570. Also, one or more of AMF 582, AUSF 530 and AAnF 570 may derive the K_{AKMA}.

In step 2, when the WTRU 502 plans to connect an AF 590 using a key bootstrapped from a primary authentication, the WTRU 502 generates a freshness parameter, and then derives K_{AF} and the key ID of K_{AF} using the freshness parameter, AF ID, WTRU ID, and the like. For routing to the correct AAnF 570 purposes, the routing information is part of the K_{AF} key ID. In examples, one of ordinary skill in the art will understand that the freshness parameter may be a random number, a number from a sequence (such as starting from 0), an arbitrary number, and so forth.

In step 3, the WTRU 502 requests the network function (NF) in the core network, for example, AAnF 570, to derive the AF key by sending one or more of the freshness parameter, the AF ID, the key ID of K_{AF}, A-KID, and the WTRU ID using a NAS message. When the AMF 582 receives the NAS request, the AMF 582 can forward the request to the AAnF 570 based on the WTRU's routing information as part of the K_{AF} key ID.

Additionally or alternatively, the WTRU 502 and AAnF 570 both derive the K_{AF} key ID using the freshness parameter. In that case the WTRU 502 does not send the K_{AF} key ID in the NAS message. The WTRU 502 may include the routing information (Routing ID) that is included as part of the A-KID in the NAS message to locate the appropriate AAnF (for example, that holds the AKMA context for the WTRU), such as AAnF 570.

In another example, the AAnF 570 can register the mapping of the K_{AF} key ID and AAnF ID with an NEF 575, when the AAnF 570 derives the K_{AF} key and K_{AF} key ID in step 3. When the NEF 575 receives the request from the AF 590 later, the NEF 575 can send the request to the correct AAnF properly.

In Step 4, the AAnF 570 derives the K_{AF} Key and the K_{AF} Key ID in the same way as the WTRU 502, using the same KDF and input parameters. The AAnF 570 then stores the K_{AF} to be ready for retrieval by the AF 590.

In Step 5, the AAnF 570 confirms the K_{AF} key derivation. Accordingly, the AAnF 570 may perform a key confirmation of the K_{AF} key with the K_{AF} ID.

In Step 6, the WTRU 502 sends the application session establishment request to the AF 590 along with the K_{AF} ID. To protect user privacy, the global unique K_{AKMA} Key ID A-KID is not used between the WTRU 502 and the AF 590. Instead, the derived K_{AF} Key ID is used, which is AF 590 specific and therefore the derived K_{AF} Key ID usage avoids the A-KID leakage and linkage issues identified by many security researchers.

The WTRU 502 generates a one-time integrity key using K_{AKMA}, a nonce such as a counter, and the like, as the inputs to a key derivation function. Also, the WTRU 502 integrity protects the parameters such as the AF ID and WTRU ID to be sent in the session establishment request to the AF 590.

Additionally or alternatively, the freshness parameter can be included in the application session establishment request along with K_{AF} Key ID, AF ID, and WTRU ID, if the freshness parameter is not sent to the core network NF (such as AAnF 570) in step 3.

In an example, the K_{AF} Key ID in the request from the WTRU 502 to the AF 590 contains the Routing Indicator. The Routing Indicator will be used to route the request to the correct AAnF, such as AAnF 570, when the NEF 575 receives the request from the AF 590 in the step 7.

In step 7, the AF 590 establishes a secure communication session with the AAnF 570 in the core network, either directly or via the NEF 575, depending on whether the AF 590 is trusted by the 3GPP network. The AF 590 sends the Application Key Request/Subscription message to the AAnF 570 along with the K_{AF} ID. The message contain may contain or more of the K_{AF} Key ID, AF ID, WTRU ID, and the like.

After the AAnF 570 in the 3GPP core network authenticates and authorizes the AF 590, the AAnF 570 generates the one-time integrity key in the same way as the WTRU (with K_{AKMA}, the nonce such as a counter, and the like as the inputs to a key derivation function). The AAnF 570 then validates the integrity of the parameters. If the integrity protected AF ID is the same as the AF ID that sends the request, the AAnF 570 in the 3GPP core network derives the K_{AF} key and Key ID. Then AAnF 570 in the 3GPP core network compares the derived Key ID and the received Key ID. If the Key ID matches, the AAnF 570 in the 3GPP core network responds to the key request from the AF 590 with the K_{AF} Key, K_{AF} ID, and the K_{AF} expiring time.

The AF 590 subscribes to the K_{AF} Key for key update notifications with the subscription message that can be combined with the request message. The subscription enables the AF 590 to receive notification of K_{AF} Key updates as the result of key updates from the AAnF 570 in the core network whenever the WTRU 502 performs a reauthentication, a K_{AF} expires, user service changes, subscription changes, a key invocation is performed, and the like. In this case, the AAnF 570 in the core network updates the K_{AF} Key and notifies the AF 590 of the new key K_{AF}.

Additionally or alternatively, the AF 590 forwards the freshness parameter to the AAnF 570 in the key request/subscription message, along with the KAF Key ID, AF ID, and the AF ID integrity protected by the WTRU 502 if the freshness parameter was not sent to the core network in step 3.

In Step 8, when the core network receives the K_{AF} Key ID in the key request from the AF 590, the AAnF 570 in the core network authenticates and authorizes the AF.

After the AF 590 authentication and authorization, the AAnF 570 generates the one-time integrity key in the same way as the WTRU 502 (with K_{AKMA}, the same nonce as used by the WTRU 502, and the like as the inputs to a key derivation function). The AAnF 570 then validates that the integrity of the parameters such as the integrity protected AF ID is the same as the AF ID of the AF 590 that sends the request.

After the AF ID validation, the AAnF 570 retrieves the K_{AF} using the received K_{AF} ID, and sends the K_{AF} Key and the K_{AF} expiring time back to AF 590.

Additionally or alternatively, if the freshness parameter was not received in the step 3, the AAnF 530 authenticates and authorizes the AF 590, and then the AAnF 570 generates the one-time integrity key in the same way as the WTRU 502 (with K_{AKMA}, the same nonce as used by the WTRU 502, and the like as the inputs to a key derivation function). The AAnF 570 then validates the integrity of the parameters, such as that the integrity protected AF ID is the same as the AF ID of the AF 590 that sends the request. The AAnF 570 then extracts the freshness parameter, AF ID, and WTRU ID. If the integrity protected AF ID is the same as the AF ID of the AF 590 that sends the request, the AAnF 570 derives the K_{AF} key and Key ID using the same KDF and input parameters as used by the WTRU 502. Then AAnF 570 compares the derived Key ID and the received Key ID. If the derived Key ID matches the received Key ID, the AAnF 570 responds to the key request from the AF with the K_{AF} Key and the K_{AF} expiring time.

In Step 9, the AF 590 responds to the WTRU 502 for the Application Session Establishment request after receiving the K_{AF} from the AAnF 570.

In Step 10, The AF 590 and the WTRU 502 perform mutual authentication based on the K_{AF}. After the mutual authentication, the WTRU 502 and the AF 590 start to protect the session using the session keys derived from K_{AF} Key. Security protected communication may then proceed from this point.

Additionally or alternatively, in Step 11, if K_{AKMA} is refreshed, for example due to reauthentication, subscription update, key expiration, and the like, the K_{AKMA} refresh triggers the update of the K_{AF} between the WTRU 502 and the AAnF 570.

Additionally or alternatively, in Step 12, the AAnF 570 sends the K_{AF} update notification to the AF 590 with the new K_{AF}, K_{AF} ID, and K_{AF} expiring time.

Additionally or alternatively, in Step 13, the WTRU 502 and AF 590 continue to protect the existing session using the session keys derived from the new K_{AF} Key. This protection may continuate during and after an application session update.

Embodiments and examples provided herein include parameter concealment between the WTRU and the AAnF in the core network. A WTRU may encrypt privacy sensitive parameter(s) send to the AF during an application session establishment procedure. The AF forwards the confidentiality protected parameters to the AAnF to establish the AF security credential between the WTRU and the AF. Before secure communication between the WTRU and the AKMA capable AF can start, the WTRU and the AF need to bootstrap the application layer key K_{AF} from the K_{AKMA}.

Examples in FIG. 4 and related text above show a trusted AF within the trusted PLMN core interacts with the AAnF and the key K_{AF} is generated to secure the communication between the WTRU and the AF. An untrusted AF outside the PLMN core interacts with the AAnF via the network exposure function NEF, and a key K_{AF} is generated similar to the procedure in FIG. 4 with an NEF (not shown) between AAnF and the AF.

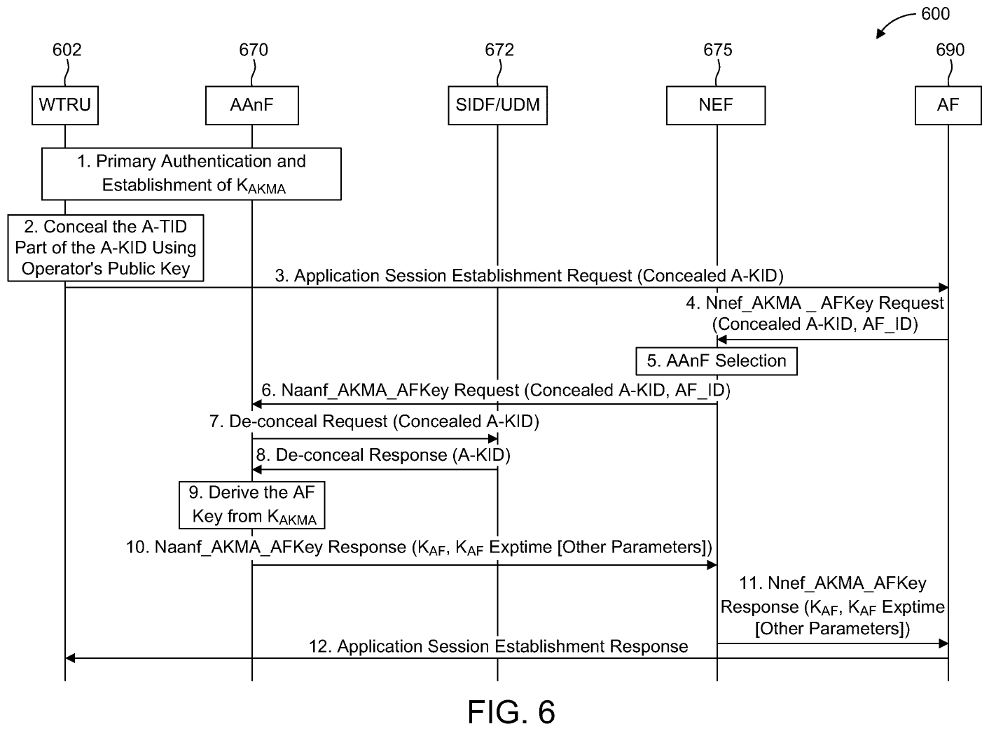

FIG. 6 is a signaling diagram illustrating an example of a concealment of a parameter between a WTRU and an AAnF. As shown in an example in signaling diagram 600, after a WTRU 602 and the network perform a successful primary authentication, both sides derive a K_{AKMA} for the purpose of key bootstrapping for secure communication between the WTRU 602 and an AF 690, in step 1. The network side key is then stored in an AAnF 670. In this way, K_{AKMA} key establishment may be performed. In an example, WTRU 602 may be the same as or similar to WTRU 102.

When the WTRU 602 is ready to establish security connection with an AF 690, the WTRU 602 protects any parameters such as A-KID using operator's public key, in step 2. A concealment method may be based on an integrated encryption scheme, for example, an Elliptic Curve Integrated Encryption Scheme (ECIES).

The A-TID is concealed using the operator's public key before it is sent to the AF 690. The A-KID is in NAI format as specified, i.e., username@realm. In examples, the NAI format may be as specified in clause 2.2 of Internet engineering task force (IETF) request for comments (RFC) 7542. The username part includes the Routing Identifier that is used to route an AF key request from the AF 690 to the AAnF 670 associated with the WTRU 602. Further, the A-TID is the AKMA Temporary WTRU Identifier, and the realm part includes Home Network Identifier. For A-KID concealment purposes, only the A-TID part is concealed, and the Routing Identifier is in clear text form.

When, in step 3, the WTRU 602 initiates communication with the AF 690, the WTRU 502 includes the concealed A-KID in the Application Session Establishment Request message. The WTRU 602 may derive a K_{AF} before sending the message or afterwards.

In step 4, the AF 690 identifies the home public land mobile network (HPLMN) of the WTRU 602 based on the realm part of the A-KID, and sends the request towards the AAnF 670 via an NEF 675 service application programming interface (API), if the AF 690 is untrusted. If the AF 690 is trusted, the AF 690 can send the request directly to the AAnF 670 without going through the NEF 675. The request shall include the concealed A-KID and the AF_ID. The request may be an Nnef_AKMA_AFKey_Request message.

If, in step 5, the AF 690 is authorized by the NEF 675 to request a K_{AF}, the NEF 675 selects the AAnF, such as AAnF 670, based on the Routing Identifier of the A-KID, local configuration, or via an NRF.

In step 6, the NEF 690 forwards the K_{AF} request to the selected AAnF 670. The request may be an Nnef_AKMA_AFKey_Request message.

Upon receiving the request from the NEF 675, the AAnF 670 checks the authorization of the AF 690 based on the configured local policy, based on the authorization information, or based on policy provided by the NRF using the AF ID. If not authorized, the AAnF 670 shall reject the request.

Otherwise, the AAnF 670 sends the request to a UDM/SIDF 670, in step 7, to de-conceal the A-KID along with concealed A-KID. The UDM/SIDF 672 is responsible for de-concealment of the A-KID, and the SIDF shall resolve the A-TID part from the A-KID based on the protection scheme used to generate the concealed A-TID as the WTRU 602 used in the step 2.

In step 8, the UDM/SIDF 672 responds back to the AAnF 670 with the de-concealed A-KID.

The AAnF 670 locates the AKMA context using the de-concealed A-KID. If the AAnF 670 already has a K_{AF} and K_{AF} expiry time associated with the AF 690 in stored the key context, the AAnF 670 may response back to the AF 690 with the same K_{AF} and the same or an updated K_{AF} expiry time. Otherwise, in step 9, the AAnF 670 derives the Application Key K_{AF} from K_{AKMA} if the AAnF 670 does not already have the K_{AF}. The AAnF 670 stores the K_{AF} along with its expiry time and AF_ID in the AKMA context.

In step 10, the AAnF 670 responds to NEF 675 with a Naanf_AKMA_ApplicationKey_Get response along with K_{AF} and the K_{AF} expiration time.

In step 11, the NEF 675 forwards the response to the AF 690. When the AF 690 receives the K_{AF} and K_{AF} expiry time, the AF 690 checks if it already stored the key context with the same K_{AF} and K_{AF} expiry time. The AF 690 may reject a WTRU 602 request if a K_{AF} already exists, or if the key is expired.

In step 12, the AF 690 responds to the WTRU 602 with the Application Session Establishment request after receiving the K_{AF} from the AAnF 670.

In another example, the WTRU 602 may generate a SUCI in step 2 and send it to the AF 690 in step 3. The AF 690 may request a K_{AF} by sending the SUCI (instead of an A-KID in steps 4 and 6). The AAnF 670 de-conceals the SUCI (instead of the A-KID) into a SUPI (steps 7 and 8) and locates the AKMA context based on the SUPI (instead of a de-concealed A-KID, in step 9).

If the AF 690 is a trusted function, it can request the de-concealment of the A-KID (or SUCI) directly from the SIDF/UDM. If the AF 690 is an untrusted function, it requests the de-concealment of A-KID by SIDF/UDM via the NEF 675. The AF 690 receives the de-concealed A-KID (or SUPI) from SIDF/UDM (directly or via NEF 675) and verifies that it has no valid K_{AF} key stored associated with the de-concealed A-KID (or SUPI). If AF 690 does not have a valid K_{AF}, the AF 690 proceeds with the conventional procedure to request a new K_{AF} from AAnF 670 (for example, passing the de-concealed A-KID and AF_ID).

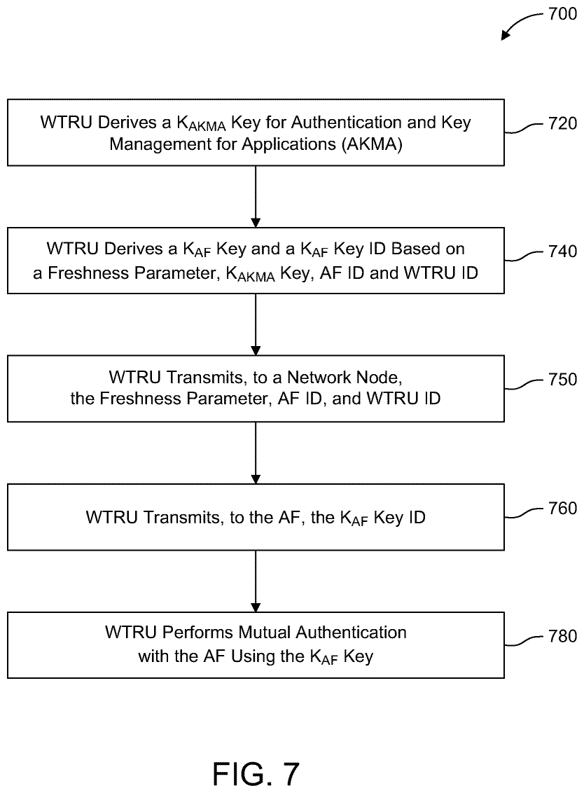

FIG. 7 a flowchart diagram illustrating an example of privacy protected AF Key bootstrapping. As shown in flowchart diagram 700, a WTRU derives a K_{AKMA} key for AKMA 720. Also, the WTRU derives a K_{AF} key for an AF and a K_{AF} key ID identifying the K_{AF} key 740. Further, the K_{AF} key and a K_{AF} key ID are derived based on a freshness parameter, the K_{AKMA} key, an AF ID identifying the AF, and a WTRU ID identifying the WTRU 740. The WTRU then transmits, to a network node, the freshness parameter, the AF ID and the WTRU ID 750. Also, the WTRU transmits, to the AF, the K_{AF} key ID 760. Moreover, the WTRU performs mutual authentication with the AF using the K_{AF} key 780.

In an example, the WTRU may also receive a key establishment confirmation, from the AF, for the K_{AF} key. Additionally or alternatively, the WTRU transmits a first secure message, to the AF, using one or more first session keys derived from the K_{AF} key. Additionally or alternatively, the WTRU receives a second secure message, from the AF, using one or more session keys derived from the K_{AF} key.

In a further example, a network node derives a K_{AKMA} key for AKMA. Further the network node receives, from a WTRU, a freshness parameter, an AF ID identifying an AF, and a WTRU ID identifying the WTRU. Also, the network node derives a K_{AF} key for an AF and a K_{AF} key ID identifying the K_{AF} key. Further, the K_{AF} key and a K_{AF} key ID are derived based on the freshness parameter, the K_{AKMA} key, the AF ID, and the WTRU ID. Moreover, the network node transmits, to the AF, a key response message including the K_{AF} key.

Additionally or alternatively, the WTRU transmits the K_{AF} key ID to the network node. Additionally or alternatively, the network node is an AAnF. Additionally or alternatively, the network node may receive, from the AF, a key request including the K_{AF} key ID.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless transmit/receive unit (WTRU), the method comprising:
deriving a K_{AKMA} key for authentication and key management for applications (AKMA);
deriving a K_{AF} key for an application function (AF) and a K_{AF} key identity (ID) identifying the K_{AF} key, wherein the K_{AF} key and a K_{AF} key ID are derived based on a freshness parameter, the K_{AKMA} key, an AF ID identifying the AF, and a WTRU ID identifying the WTRU;
transmitting, to a network node, the freshness parameter, the AF ID and the WTRU ID;
transmitting, to the AF, the K_{AF} key ID; and
performing mutual authentication with the AF using the K_{AF} key.

2. The method claim 1, further comprising:
receiving a key establishment confirmation, from the AF, for the K_{AF} key.

3. The method claim 1, further comprising:
transmitting a first secure message, to the AF, using one or more first session keys derived from the K_{AF} key.

4. The method claim 1, further comprising:
receiving a second secure message, from the AF, using one or more session keys derived from the K_{AF} key.

5. The method claim 1, further comprising:
transmitting the K_{AF} key ID to the network node.

6. The method claim 1, wherein the network node is an AKMA anchor function (AAnF).

7. A network node comprising:
a processor operatively coupled to a transceiver; wherein the processor and transceiver are configured to:
derive a K_{AKMA} key for authentication and key management for applications (AKMA);
receive, from a wireless transmit/receive unit (WTRU), a freshness parameter, an AF ID identifying an AF, and WTRU ID identifying the WTRU; and
derive a K_{AF} key for the AF and a K_{AF} key ID identifying the K_{AF} key, wherein the K_{AF} key and a K_{AF} key ID are derived based on the freshness parameter, the K_{AKMA} key, AF ID and WTRU ID; and
transmit, to the AF, a key response message including the K_{AF} key.

8. The network node of claim 7, wherein the processor and transceiver are further configured to:
receive, from the AF, a key request including the K_{AF} key ID.

9. The network node of claim 7, wherein the network node is an AKMA anchor function (AAnF).

10. A wireless transmit/receive unit (WTRU) comprising:
a processor operatively coupled to a transceiver; wherein the processor and transceiver are configured to:
derive a K_{AKMA} key for authentication and key management for applications (AKMA);
derive a K_{AF} key for an application function (AF) and a K_{AF} key identity (ID) identifying the K_{AF} key, wherein the K_{AF} key and a K_{AF} key ID are derived based on a freshness parameter, the K_{AKMA} key, an AF ID identifying the AF, and a WTRU ID identifying the WTRU;
transmit, to a network node, the freshness parameter, the AF ID and the WTRU ID;
transmit, to the AF, the K_{AF} key ID; and
perform mutual authentication with the AF using the K_{AF} key.

11. The WTRU of claim 10, wherein the processor and transceiver are further configured to:
receive a key establishment confirmation, from the AF, for the K_{AF} key.

12. The WTRU claim 10, wherein the processor and transceiver are further configured to:
transmit a first secure message, to the AF, using one or more first session keys derived from the K_{AF} key.

13. The WTRU claim 10, wherein processor and transceiver are further configured to:
receive a second secure message, from the AF, using one or more session keys derived from the K_{AF} key.

14. The WTRU claim 10, wherein processor and transceiver are further configured to:
transmit the K_{AF} key ID to the network node.

15. The WTRU claim 10, wherein the network node is an AKMA anchor function (AAnF).
